(19) United States
(12) Patent Application Publication
(10) Pub. No.: US 2020/0300225 A1
(43) Pub. Date: Sep. 24, 2020

(54) MEASURING SYSTEM FOR MEASURING A SURFACE OF A ROTOR BLADE OF A WIND TURBINE

(71) Applicant: Wobben Properties GmbH, AURICH (DE)

(72) Inventors: Heiner SWEERS, Bremen (DE); Andree ALTMIKUS, Aurich (DE)

(21) Appl. No.: 16/088,376

(22) PCT Filed: Mar. 29, 2017
(86) PCT No.: PCT/EP2017/057436

§ 371 Date: Sep. 25, 2018

(30) Foreign Application Priority Data
Apr. 1, 2016 (DE) 10 2016 205 469.4

(51) Int. Cl. F03D 17/00; G01B 11/245

(52) U.S. Cl. CPC F03D 17/00; F05B 2240/20; G01B 11/245

(57) ABSTRACT

A measurement system and a measurement method for measuring a surface of a rotor blade of a wind power installation as a measured object. The measurement system comprises: a carrier unit having a plurality of measurement sensors arranged in a measurement plane, wherein the measurement system is configured to align the measurement plane with a profile section of the measured object, a movement unit which is configured to move the carrier unit relative to the measured object in a longitudinal direction that is at an angle to the measurement plane, and an advancing unit which is configured to advance at least one measurement sensor in the measurement plane relative to the profile section. The measurement system and the measurement method facilitate an accurate measurement of the surface of the measured object with reduced outlay.

### BACKGROUND

### Technical Field

The present invention relates to a measurement system and measurement method for measuring a surface of a rotor blade of a wind power installation as a measured object.

### Description of the Related Art

The measurement of surfaces of measured objects is connected with great outlay, particularly in the case of measured objects with a great extent and/or a complicated geometry. In many fields of application, for example in the field of quality assurance of rotor blades of a wind power installation, the surface must be measured at a high resolution such that a meaningful fluid dynamics simulation can be carried out. Only with the aid of such a high-resolution measurement system is it possible to obtain a three-dimensional image of the rotor blade as manufactured, on the basis of which areal deviations from tolerance prescriptions can be diagnosed and evaluated in respect of their effects on power and sound during the operation of the installation. Integrating the measurement method into the production process within the scope of the final control renders it possible to perform rectification of defects and reduce rejects.

A currently known measurement system or measurement method is based on the use of profile templates. Profile templates are placed at certain positions of the measured object in order to be able to detect deviations from the profiles defined by the profile templates. Disadvantages of this method are that the positioning of the templates is inaccurate and that such a measurement can only be carried out for a few profile sections on the measured object, such as the rotor blade, for example, within a realistic timeframe. Consequently, the known method is inaccurate and, moreover, connected to great time outlay.

EP 0 364 907 A2 discloses a method for determining the geometry of a body in a forging press, wherein the body in the forging press is displaced and rotated about the longitudinal axis in a predetermined manner for the purposes of processing for a processing run through.

GB 2 335 488 A comprises a method for determining the size and/or form of a sequence of products which move over a gap between conveyor belts. To this end, distance measurement appliances are fastened at a ring.

U.S. Pat. No. 4,815,857 A discloses a method for measuring a pipe, for example, said method comprising the steps of the pipe being kept in a measurement region which is scanned by light beams. The light beams are moved at right angles to one another in a plane until shadows arise and disappear as result of the pipe. At these points, the positions of the light sources of the light beams and the light sensors are measured and the shadowing is recorded. The scanning plane is displaced at right angles to the measurement plane, the displacement is measured and the process is repeated.

DE 101 08 812 A1 discloses a method and an apparatus for contactlessly establishing and measuring the surface contour of measured objects, in particular section tubes, using a laser measurement system, wherein the measured object and the laser measurement system are moved in linear and rotational fashion relative to one another.

DE 38 85 714 T2 discloses a measurement apparatus and a measurement method which are particularly suitable for undertaking measurements on objects that have a substantially circular cross section.

U.S. Pat. No. 4,146,967 A discloses an apparatus for measuring the contour of helicopter rotor blades. The apparatus or fastening means of the present invention measures airfoil profile form and twist at each position along the rotor blade, and the chordwise and flapwise bow of the rotor blade.

However, none of the known systems discloses a measurement system which takes account of the particular requirements of the geometry of wind power installation rotor blades. Wind power installation rotor blades differ multiple times in the cross section between a region in the vicinity of the hub and the tip region of the rotor blade. Nevertheless, it is important to be able to measure the surface of the rotor blade precisely, i.e., with an unchanging high resolution, over the entire blade length.

### BRIEF SUMMARY

Provided are a measurement system and a measurement method for measuring a surface of a rotor blade of a wind power installation as a measured object, said measurement system and measurement method facilitating an accurate measurement of the entire surface of the measured object with reduced outlay.

Provided is a measurement system for measuring a surface of a rotor blade of a wind power installation as a measure object. The measurement system comprises a carrier unit with a plurality of measurement sensors arranged in a measurement plane, a movement unit and an advancing unit. The measurement system is configured to align the measurement plane with a profile section of the measured object. The movement unit is configured to move the carrier unit relative to the measured object in a longitudinal direction that is at an angle to the measurement plane. The advancing unit is configured to advance, i.e., position, at least one measurement sensor in the measurement plane relative to the profile section.

The measurement sensors are configured as laser light section sensors. Laser light section sensors allow a precise and reliable measurement of a height profile, in this case of the surface of the measured object, in the measurement plane of the profile section. By virtue of it being possible to move the carrier unit relative to the measured object by means of the movement unit, the measurement system is able to capture profile sections over the entire measured object without actively moving the measured object. Consequently, by way of the movement unit, the carrier unit can drive over a rotor blade of a wind power installation, for example, along the length of the latter. Consequently, the movement allows a measurement of the surface with a reduced outlay since, for example, it is possible to dispense with interchanging and adapting the templates of the known method.

By capturing a profile section in the measurement plane and by way of a relative movement in relation thereto in a direction that does not lie in in the plane of the profile section, it is possible to combine a plurality of profile sections, captured at a plurality of positions of the measured object, to form the overall surface of the measured object.

Preferably, the measurement plane is perpendicular to the longitudinal direction. However, in other embodiments, the measurement plane can also be at an angle in relation to the longitudinal direction for as long as the measurement plane does not lie parallel to the longitudinal direction. Preferably, a longitudinal direction of the measured object is aligned with the longitudinal direction of the measurement system. By way of example, the longitudinal direction of the measured object is the direction in which the measured object exhibits the greatest extent. The measurement system is suitable, in particular, for elongate measured objects. In addition to rotor blades, aircraft wings, for example, and the like may be considered here.

It is possible to advance at least one of the measurement sensors in the measurement plane, i.e., the distance between measurement sensor and measured object can be modified, by means of the at least one advancing unit. Consequently, it is possible to ensure that the distance between measurement sensor and measured object is always situated within a region in which a resolution of the measurement sensor is sufficiently high in relation to the surface of the measured object and, consequently in relation to the profile section. This is particularly advantageous for rotor blades of wind power installations, which vary strongly in their cross section.

The advancing unit is configured to advance to a distance between the at least one measurement sensor and the measured object in such as, a way that a requirement in respect of a measurement resolution of the measurement sensor in respect of the surface of the rotor blade is satisfied both in a hub region of the rotor blade and in a blade-tip region.

The resolution of curved surfaces depends strongly on the radius of the surface curvature. Therefore, a constant high resolution can be obtained for rotor blades of wind power installations by changing the distance between the sensor and measured object. Consequently, in the example of a rotor blade, it is possible to ensure that both a hub region, which has a very large cross section, and a blade-tip region, which has a significantly smaller cross section, can be measured with a sufficient measurement resolution such that, for example, the requirements for fluid dynamics simulations or the like are satisfied.

Hence, a local measurement accuracy of the profile leading and trailing edge preferably can lie in the range from 0.05 to 0.17 mm on the pressure side and from 0.07 to 0.41 mm on the suction side. It is possible, within these tolerance ranges, to maintain a guarantee for power values or acoustic values of the rotor blade, wherein, naturally, other tolerance ranges are also maintainable according to the requirements of the rotor blade.

Further, the advancing unit can be suitable for advancing at least one of the measurement sensors in such a way that an inaccessible measurement position or a hard-to-access measurement position can be captured. Also, the advancing unit allows obstacles in the travel, i.e., along the path that the measurement system moves by means of the movement unit, to be avoided. By way of example, the measured object can be supported by a support or the like and the advancing unit can be moved out of the measurement plane at the place in the travel at which the support is situated in such a way that the support does not impair the travel.

In a preferred embodiment, the advancing unit is configured to advance a plurality of the measurement sensors; particularly preferably, the advancing unit is configured to advance all of the measurement sensors.

In an embodiment, the advancing unit has a mechanical advancing element which is configured to mechanically advance the measurement sensor. A mechanical advance allows a better measurement resolution to be obtained without the occurrence of optical artifacts or aberrations, as a result of which the measurement of the measured object is optimized.

In an embodiment, the advancing unit has a linear advancing element and an axis of the advancing element extends in the measurement plane. Consequently, all measurement sensors of the carrier unit lie in the same measurement plane, independently of the position of the measurement sensor in relation to the advancing element. Consequently, with respect to the measured object, all measurement sensors can capture the profile section in a profile plane, namely the measurement plane.

In an embodiment, the advancing unit comprises a hydraulic cylinder.

Hydraulic cylinders facilitate an accurate advance of the measurement sensors, they are wide spread and the precise control of hydraulic cylinders is also possible without difficulties.

In an embodiment, the measurement sensors are each configured to capture part of the profile section of the measured object in the measurement plane. Further, the measurement system has a calculation unit which is configured to combine the captured parts of the profile section to form an overall profile section. Preferably, the parts of the profile section captured by the respective measurement sensors overlap at least in part such that a calibration of the measurement sensors for combining the overall profile section is simplified. Seven measurement sensors were found to be advantageous for measuring rotor blades. A different number of sensors, too, are preferred in other embodiments and, for example, for different measured objects.

In an embodiment, the calculation unit further is configured to combine profile sections at different positions of the carrier unit in the longitudinal direction to form a profile of the surface of the measured object. Profile sections at different positions of the measured object are obtained by the measurement sensors by virtue of the carrier unit being moved relative to the measured object by means of the movement unit.

A profile can be embodied as a collection of profile sections in two dimensions or as a three-dimensional surface, which is obtained, for example, by interpolation of the profile sections or of points of the profile sections.

In an embodiment, the calculation unit is configured to compare the captured profile section or the captured profile to a reference profile section or a reference profile, and to determine if a deviation between the reference profile section or the reference profile and the captured profile section or profile exceeds a predetermined tolerance value. In this embodiment, the calculation unit can consequently compare a profile section or a profile produced from a plurality of profile sections to a reference profile section or a reference profile. By way of example, the reference profile section or the reference profile is a computer model or a target value of the measured object. Deviations from the reference profile may have negative effects on properties of the measured object, for example on the development of noise or the power curve in the example of the rotor blade. If the deviation exceeds a predetermined tolerance value, the assumption can be made that the production is faulty and possibly needs to be rectified. Advantageously, this can be used in a quality assurance method in order to select rejects or to be able to undertake rectification of defects.

In an embodiment, the calculation unit further is configured to undertake a correction of the captured profile section or of the captured profile on the basis of an inherent weight of the measured object and gravity. Depending on how the measured object is mounted, sagging may be determined in the center of the measured object, particularly in the case of long measured objects. These deviations, which may be significant depending on the measured object, are corrected by the calculation unit such that deviations between the reference profile and captured profile that are based on the inherent weight of the measured object are not unjustifiably determined as a defect on the measured object.

In an embodiment, each of the measurement sensors comprises a laser section source and a camera, which is preferably an optical camera. The camera is configured to capture a reflection of a laser line of the laser section source from the rotor blade.

Preferably, the camera is configured to adapt the exposure time in such a way that only the light of the laser section source is captured and the recording is not disturbed by ambient light. To this end, a light intensity of the laser section source is preferably high such that the exposure time of the camera can be selected to be correspondingly short.

Furthermore, the measurement sensors preferably each comprise a calibration system, which allows 3 spatial degrees of freedom and 3 rotational degrees of freedom of the measurement sensor to be determined independently of one another.

In an embodiment, the carrier unit is embodied as a portal, wherein the measurement sensors are directed in the direction of the interior of the portal. That is to say that, during a measurement, the measurement sensors are arranged around the measured object. In this embodiment, the measurement sensors are aligned onto the measured object from the outside, said measured object then being situated in the interior of the portal during a measurement. Consequently, profile sections and also the profile of the outer surface of the measured object can be measured by means of the measurement system. Preferably, the portal is dimensioned in such a way that it can be arranged around the measured object over an entire length of the measured object. Preferably, the measurement sensors are arranged around the measured object in such a way that it is possible to combine a complete profile section by means of the measurement sensors at each longitudinal position of the measured object.

In another embodiment, the carrier unit is configured to be arranged within the profile section of the measured object, wherein the measurement sensors are directed away from the carrier unit to the outside. In this embodiment, the measurement system is configured to measure the surface of the measured object, for example from the inside. By way of example, a mold for producing a rotor blade is a measured object that can be preferably measured with the measurement system of this embodiment. In this way, it is possible to avoid errors that arise in the rotor blade even before the rotor blade is manufactured.

Preferably, in an embodiment, the position of the measurement sensors can be modified depending on the measured object. In the case in which the geometry of the surface of the measured object has no projections or the like, the measurement sensors can simply be aligned in the direction of the center of the portal. If the surface of the measured object renders it necessary, other alignments of individual measurement sensors, for example not in the direction of the center of the portal, may become necessary. In an embodiment, at least one measurement sensor has a rotational unit that is configured to rotate the measurement sensor in the measurement plane with respect to the carrier unit.

In an embodiment, the movement unit has a guide component and a drive component, wherein the guide component defines the longitudinal direction and the movement unit is configured to move the carrier unit along the guide component by means of the drive component.

Preferably, the guide component comprises a rail, and the drive component is preferably designed corresponding to a longitudinal direction of the measured object. The guide component need not be linear but may also be curved or have a different extent, for example in order to follow the form of the measured object.

In an embodiment, the measurement system further has a position determination unit, which is configured to determine the position of the carrier unit along the longitudinal direction. By virtue of the position determination unit being able to determine a position of the carrier unit, an assignment of a captured profile section to a longitudinal position is possible in a simple and precise manner. In an embodiment, the position determination unit is configured to determine the position on the basis of a relative movement of the carrier unit by means of the movement unit.

In an embodiment, the position determination unit has a position laser. The position of the carrier unit can be determined exactly by means of the position laser. The position determination unit preferably comprises a fixed component, the position of which is stationary during a measurement, and a movable component, which is attached to the carrier unit and moves with the carrier unit relative to the measured object. The distance between fixed component and movable component then corresponds to the position of the carrier unit along the longitudinal direction.

In an embodiment, the position determination unit comprises a retroreflector, which is attached to the carrier unit in such a way that said retroreflector is guided along a circular or elliptical trajectory at or around the carrier unit. The position and the orientation of the carrier unit can be determined at all times from the trajectory of the retroreflector, which is helical as a result of the relative movement of the carrier unit.

Provided is a measurement method for measuring a surface of a measured object. The measurement method comprises the steps of: aligning a carrier unit with a plurality of measurement sensors, arranged in a measurement plane, with a profile section of the measured object, moving the carrier unit in a longitudinal direction, at an angle to the measurement plane, relative to the measured object, and advancing at least one of the measurement sensors in the measurement plane relative to the profile section. Preferably, the measured object is a rotor blade of a wind power installation.

Advancing at least one of the measurement sensors need not be carried out at each profile section. By way of example, advancing of the measurement sensor during a movement of the carrier unit can be carried out discontinuously if the assumption is made that the measured object is situated in the focus of the measurement sensor for a while. Consequently, the measurement sensor supplies a sufficient accuracy over a certain travel of the measurement system in the longitudinal direction and is only subsequently advanced when a region of focus is left. However, in other embodiments, it may also be advantageous to advance the measurement sensor by means of the advancing element after each profile section, or to advance the measurement sensor continuously. In the same way, the carrier unit can be moved continuously, or discontinuously, in the longitudinal direction, wherein the movement of the carrier unit is interrupted in this case for the purposes of measuring respective profile sections.

By virtue of at least one of the measurement sensors being advanced relative to the profile section in the measurement plane, it is possible to ensure a resolution of the measurement sensor in respect of the surface of the measured object by virtue of the distance being adapted between the measurement sensor and the profile section. Hence, a high quality of the measurement is ensured. Capturing a plurality of profile sections is easily possible on account of the movement, reducing the outlay for measuring the measured object.

In an embodiment of the measurement method, at least one profile section of the measured object is captured before and after moving the carrier unit and advancing at least one of the measurement sensors. By capturing a plurality of profile sections of the measured object at different positions in the longitudinal direction, it is possible to easily reconstruct the surface of the measured object on the basis of the plurality of profile sections.

In an exemplary embodiment, the surface is calculated by interpolation between the profile sections, which are captured at different positions of the carrier unit. Expressed differently, a plurality of two-dimensional profile sections from the measurement plane are interpolated to form a three-dimensional profile of the surface. The profile sections and the profile can be present in all conceivable data structures, e.g., as point clouds, vectors, etc.

Part of a profile section, which is captured by a measurement sensor, varies depending on an advance position of the measurement sensor. The conversion of the captured profile sections is carried out on the basis of the position of the measurement sensor, at which the latter is situated on account of the advance. Expressed differently, the advance position of the measurement sensor Preferably, a calibration of the measurement sensors among themselves is configured in such a way that the measurement sensors are calibrated to one another for all positions of the measurement sensors, as may be obtained by the advance.

In an embodiment of the measurement method, a position of the carrier unit in the longitudinal direction is captured for each profile section. This renders combining the profile sections to form a surface of the measured object easily possible since the position of the profile sections relative to one another is known.

In an embodiment of the measurement method, at least one profile section is corrected depending on its position in the longitudinal direction. In particular, the position, specifically the height, of the profile section can be corrected in relation to the measurement plane. On account of the inherent weight and mounting of the measured object, the measured object sags between the mounts; in the example of a rotor blade of a wind power installation, said rotor blade is mounted at its two ends and, possibly, additionally in the center. So that occurring errors, which are identifiable in the profile sections on account of this sagging, are not incorrectly identified as errors of the measured object or as deviations of the measured object from a reference object, the method comprises, in this embodiment, a correction of the respective profile sections.

In an embodiment of the measurement method, a surface profile of the measured object is calculated from the captured profile sections. The calculated surface profile may then be compared to a reference profile in order to determine possible deviations of the calculated surface profile from a reference profile. Possibly determined deviations can be used to ensure a quality of the measured object, e.g., of the rotor blade.

Independently of systematic errors which relate to the entire surface profile, it is also possible to compare individual profile sections to respective reference profile sections. Consequently, it is possible to determine possible deviations of the profile section from a reference profile section without calculating the entire surface profile. In an embodiment, a single profile section, in particular a point cloud captured by the measurement sensors, can be written onto a local reference cross section, e.g., in the form of a numerically produced spline curve, for example, by means of a “least squares fit method”. Possibly determined deviations or error metrics can be used to determine a quality of the measured object at the local position.

In an embodiment of the measurement method, at least one of the measurement sensors is advanced relative to the profile section in the measurement plane by determining the distance of the measurement sensor from the measured object. The advance based on the distance determination is preferably carried out automatically. This embodiment ensures that the distance between measurement sensor and measured object is always in the region that is preferred for the desired resolution of the measurement.

Provided is a measurement method for measuring a surface of a measured object, in particular a rotor blade of a wind power installation, using a measurement system according to the invention.

Provided is a method for quality assurance of a measured object using a measurement system. The measured object is, in particular, a rotor blade of a wind power installation and the measurement system is, in particular, a measurement system according to the invention. The measurement system initially measures a surface of the measured object at a first resolution. The surface of the measured object measured at the first resolution is compared to a reference surface. The measurement system measures the surface of the measured object at a second, higher resolution in the case where a deviation of the surface of the measured object, measured at the first resolution, from the reference surface exceeds a threshold value. Here, the renewed measurement may comprise the entire blade or else only comprise local regions in the longitudinal direction.

In a first step, the quality assurance method determines whether there are indications for a deviation of the surface of the measured object from a reference surface on the basis of a lower resolution. In the case where such deviations occur, a measurement is carried out at a second, higher resolution in order to obtain a more accurate estimate of the deviation. In the case where checking the measured object at the first resolution already suffices, it is consequently possible to dispense with a second, protracted capture. Hence, the requirements of the quality assurance method being economical and efficient can be satisfied.

By way of example, the distance between two adjacent profile sections in the longitudinal direction should be understood to mean a resolution. By way of example, a first resolution is a distance of 20 millimeters between two profile sections in the longitudinal direction and a second resolution is a distance of, for example, 2 millimeters in the longitudinal direction. Naturally, other distances are also possible, with the distance in the second resolution being shorter than the distance in the first resolution. The measurement at the first resolution requires less time since fewer profile sections are captured for the entire measured object.

All embodiments described for the measurement system can be used advantageously in the measurement method according to the invention in an analogous fashion. Likewise, elements of the measurement system according to the invention can be configured to carry out steps of the method according to the invention.

Further configurations and advantages obtained by the solutions according to the invention are described below with reference to the attached figures.

### BRIEF DESCRIPTION OF THE SEVERAL VIEWS OF THE DRAWINGS

FIG. 1 schematically shows an exemplary embodiment of a measurement system,

FIG. 2 schematically shows the functional principle of a laser section sensor,

FIGS. 3a and 3b schematically show a calibration of measurement sensors in an exemplary manner,

FIGS. 4a and 4b schematically show a position determination unit of the measurement system according to the invention in an exemplary manner,

FIG. 5 schematically shows how an example of a measured object, specifically a rotor blade of a wind power installation, is mounted in an exemplary manner and

FIGS. 6a to 6c schematically show further exemplary embodiments of a measurement system in an exemplary manner.

### DESCRIPTION OF THE RELATED ART

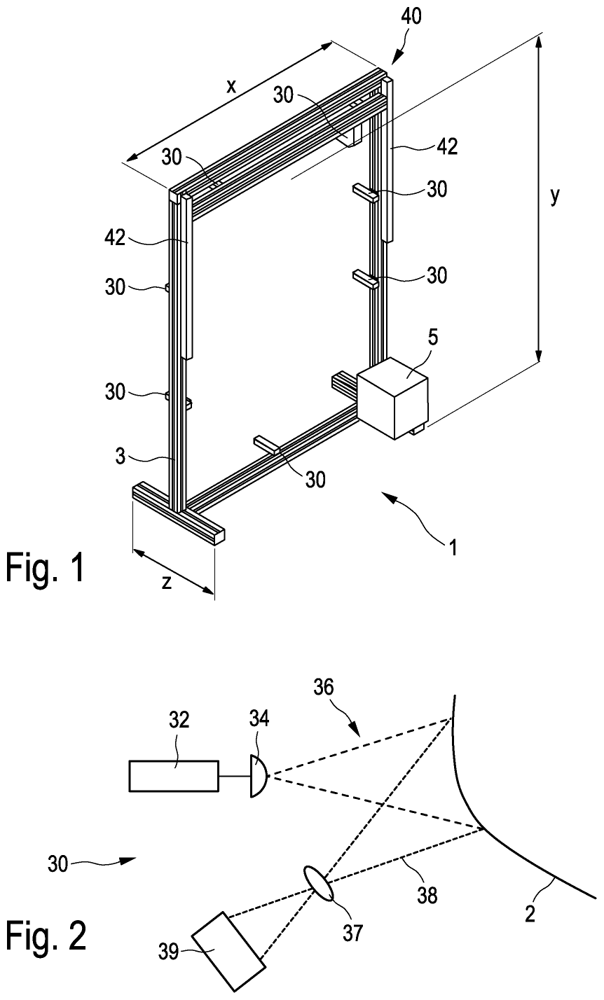

FIG. 1 schematically shows an exemplary embodiment of a measurement system 1 according to the invention. The measurement system 1 comprises a carrier unit 3, which is configured in the form of a frame, and a movement unit 5, by means of which the frame 3 can be moved. In this example, the frame extends along a width x and along a height y and it is movable by means of the movement unit 5 in a longitudinal direction z, which is perpendicular to both the width x and the height y. In this exemplary embodiment, the width x and the height y define the measurement plane of the measurement system. The selection of the axes is exemplary and may be different in other exemplary embodiments. Even though width x, height y and length z are respectively perpendicular to one another in this example, this may also be different in other exemplary embodiments.

In this example, the movement unit 5 is an electric motor which moves the measurement system 1 along the longitudinal direction z by way of a rail (not shown) on the floor, on which the frame 3 is placed, for example by means of wheels.

In this example, seven measurement sensors 30 are provided within the frame 3. The measurement sensors 30 are each directed inwardly in the measurement plane from the frame 3, onto the region in which a measured object should be inserted. In this example, two measurement sensors 30, namely the measurement sensors arranged at the upper end of the frame 3, are fastened to the frame 3 by means of an advancing unit 40. The advancing unit 40 allows the measurement sensor 30, which is fastened to the frame 3 by the advancing unit 40, to be able to be moved in the measurement plane. In this example, the advancing unit 40 comprises two parallel linear advancing elements 42, which are arranged at vertical portions of the frame 3 and which mount a horizontal carrier such that it is movable in the height direction y between the two linear advancing elements 42. In other exemplary embodiments, only one measurement sensor 30, or more than two of the measurement sensors 30, are fastened to the frame 3 by means of the advancing unit 40, preferably all of the measurement sensors 30, in particular. Each of the measurement sensors 30 may have a dedicated advancing unit 40 or a plurality of the measurement sensors 30 can be advanced using a common advancing unit 40.

FIG. 2 schematically shows the functional principle of a laser section sensor as an example of a measurement sensor 30. The measurement sensor 30 is a laser light section sensor which comprises a laser light source 32, a cylindrical lens 34, a lens 37 and detector, e.g., a camera 39. The punctiform light emitted by the laser light source 32 is split into a line by means of the cylindrical lens 34. The line emerges from the measurement sensor 30 and strikes a surface of a measured object 2. The incident laser light 36 is reflected at the surface 2 and enters into the camera 39 as a reflected line 38 via the lens 37. The height profile of the surface 2 can be calculated by the offset of the laser line incident on the camera 39. Laser light section sensors are based on the known principle of laser triangulation, with the punctiform light source being expanded into a two-dimensional line. The laser light section sensor 30 is only an example of a surface sensor that can be used in the measurement system 1 according to the invention.

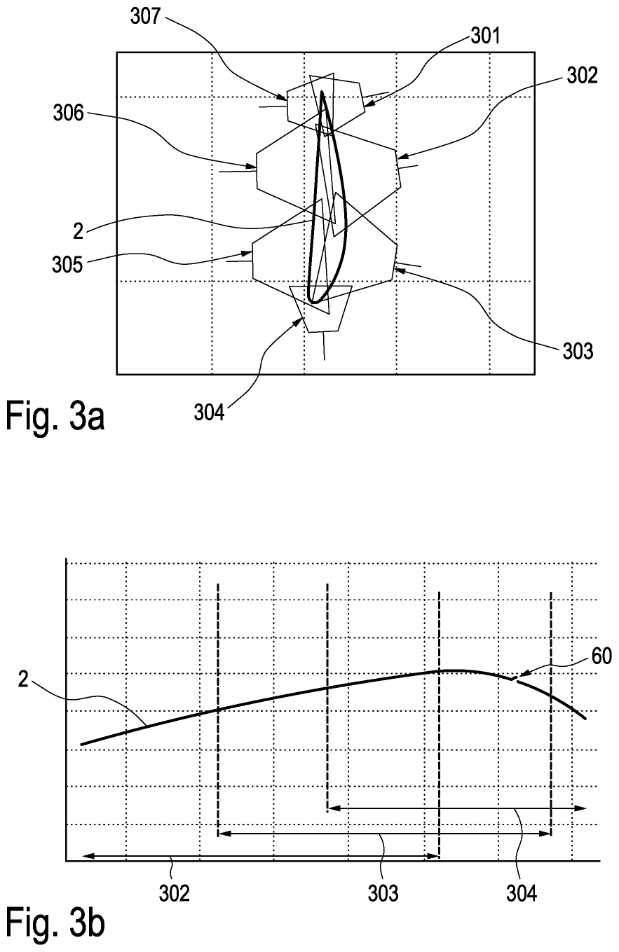

FIGS. 3a and 3b schematically show a calibration of the measurement sensors 30 in an exemplary manner. FIG. 3a illustrates the beam profile 301 to 307 of the seven measurement sensors 30 shown in FIG. 1. The beam profile first extends linearly and is then split in a fan-like manner by a cylindrical lens 34, as shown in FIG. 2. The beam profiles 301 to 307 strike the surface 2 of the measured object 2 at different positions and at different angles, using the example here of a profile of a rotor blade of a wind power installation.

The individual beam profiles 301 to 307 partly superimpose significantly; this is used for calibration and reliability, as elucidated in FIG. 3b. FIG. 3b shows a part of a profile section that is obtained by the division of the measurement sensors 30 shown in FIG. 3a. FIG. 3b only shows the parts of the profile section that are captured by three measurement sensors 30. Other measurement values of the respective adjacent sensors would also be visible in the edge region of FIG. 3b if all seven measurement sensors 30 were taken into account.

It is clear from FIG. 3b that the parts of the profile sections that originate from the respective beam profiles 302, 303 and 304 overlap in the shown portion of the profile curve. In the example shown in FIG. 3b, the profiles are such that at least two of the sensors overlap at all times and that even all three sensors overlap in the central region. As a result of the calibration of the measurement sensors 30, a profile section which is presented as a single line is produced. Expressed differently, the calibrated sensors 30 supply measurement values that fit to one another, from which an overall profile section can be calculated. FIG. 3b shows a defect 60, at which the rotor blade deviates from a usual profile. No deviation of the measurement line 303 from the measurement line 304 can be seen at the position 60 either, i.e., the defect 60 has been determined in agreement by the measurement sensor 30, from which the beam profile 303 originates, and the measurement sensor 30, from which the beam profile 304 originates.

The overlap of the individual measurement lines 302, 303 and 304 can be adapted, if necessary, in a further step in the aftermath of the measurement. By way of example, the lines can be smoothed by a suitable method, in particular by B-splines or the like. Additionally, a suitable method for producing a smooth surface can be used in the aftermath when producing a 3D (three-dimensional) surface from two-dimensional profile sections. By way of example, a NURBS surface can be fitted into the point cloud of the entire measured object. Hence, a smooth, simulation-capable surface is produced.

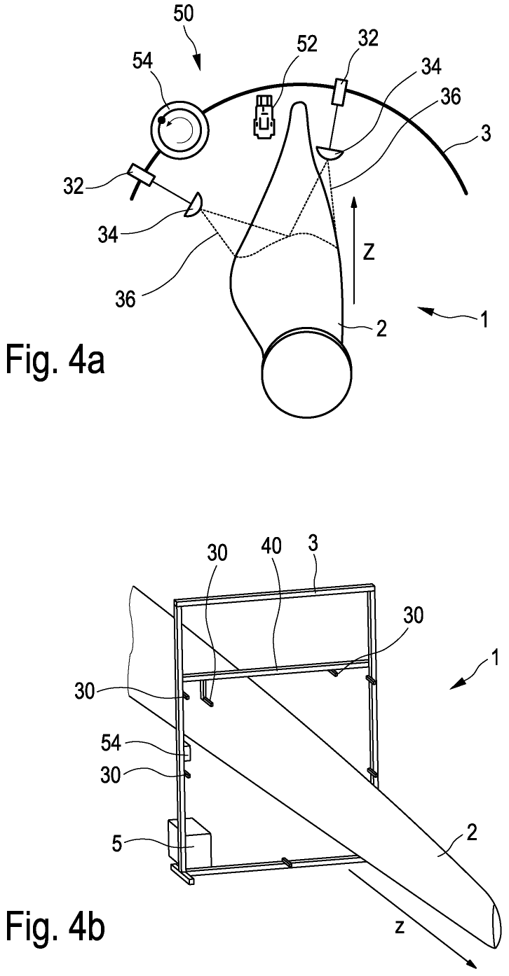

FIG. 4a schematically shows, in an exemplary manner, a position determination unit 50 which is used in a measurement system 1. In FIG. 4a, the sensors 30 are shown schematically by the laser light source 32 and the cylindrical lens 34, which are arranged on a schematic frame 3 sketched out in the form of a semicircle. Further elements of the measurement sensors 30 have been omitted for improved illustration. Further, FIG. 4a shows a rotor blade as an example of a measured object 2, which is moved along the frame 3 in the longitudinal direction z.

The position determination unit 50 has a position laser 52 and a retroreflector 54. The position laser 52 is stationary and arranged independently of the frame 3. It does not move when the frame 3 is moved by means of the movement unit 5. The position laser 52 measures the distance from the retroreflector 54, which moves with the frame 3. The retroreflector 54 reflects the radiation incident from the position laser 52 back to the position laser 52 in a way that is largely independent of the alignment of the retroreflector 54 in respect of the position laser 52. The retroreflector 54 is guided continuously on a circular or elliptical orbit. The circular or elliptical orbit of the retroreflector 54 can be effected in respect of an attachment surface, which is fastened to the frame 3, or in respect of the entire frame 3. By virtue of the frame 3 moving in the longitudinal direction Z and the retroreflector 54 simultaneously being situated on a circular or elliptical orbit, a helical trajectory emerges, from which the position and orientation of the frame 3 of the measurement system 1 can be determined at all times.

FIG. 4b schematically shows, in an exemplary manner, the measurement system 1 shown in FIG. 1 together with the measured object 2, the blade tip of a rotor blade in this example. The frame 3 is guided along the rotor blade 2, with the measurement sensors 30 capturing profile sections of the rotor blade 2 continuously or at certain intervals. Instead of the rotating retroreflector 54, a stationary retroreflector 54 is shown in the example shown in FIG. 4b. In this example, too, the retroreflector 54 can be used to determine the distance from the position laser 52 (not shown in FIG. 4b).

The measurement system 1 is suitable for capturing a three-dimensional surface geometry of a measured object 2 in an automated manner. Particularly for large dimensions of the measured object 2 and the high measurement resolution that is required for a meaningful determination of the surface geometry of the measured object 2, the measurement is not implemented from a stationary location of the measurement system 1, but instead from different positions by virtue of the frame 3 being moved by means of the movement unit 5 along the measured object 2 and the measurement sensors 30 consequently carrying out a relative movement with respect to the measured object 2 during the measurement process. A carrier unit, for example in the form of a frame 3 with a plurality of measurement sensors 30 which are, for example, optical triangulation sensors such as laser light section sensors, is guided on a rail system, for example, along the measured object 2 and precisely tracked with the aid of a position determination unit 50. By way of example, the position determination unit 50 is a position laser 52, which determines the distance to a retroreflector 54 attached to the frame 3. Thus, a sequence of complete profile sections of the measured object 2 arises. Individual measurements of profile sections can be fusioned to form a three-dimensional overall model with a high resolution. Here, too, autonomous or preprogrammed floor conveyors could be used as movement units 5 for moving a carrier unit 3. Additionally, the portal could be fastened in a freely manipulable manner to an industrial robot in order to be able to describe any spatial curve as a travel along a measured object.

The advancing component 40, which is configured to set the distance of the measurement sensors 30 from the measured object 2, ensures that the measurement resolution of the surface of the measured object 2 is sufficiently high, independently of the diameter of the measured object 2 at the position at which the current profile section is measured. Deviations of the three-dimensional overall model can be determined by a comparison with a CAD model, for example.

Significant sagging caused by gravity, occurring, in particular, in the case of long measured objects 2 such as rotor blades of a wind power installation is simulated and taken into account in the evaluation. The measurement data captured by the measurement system 1 form the basis for flow simulation for evaluating the power of the rotor blade or evaluating the rotor blade acoustically, for example, in the case of rotor blades of a wind power installation.

What the measurement system 1 can achieve is that the overall measurement time for a rotor blade is no longer than 30 minutes. Within this time, a profile section can be recorded every 2 millimeters in the longitudinal direction of the measured object 7 using the measurement system 1. Using the measurement system, the local measurement inaccuracy at the profile leading and trailing edge can lie in the region from 0.05 to 0.17 mm on the pressure side and from 0.07 to 0.41 mm on the suction side. Within these tolerance ranges, there can be a guarantee for power values or acoustic values of the rotor blade.

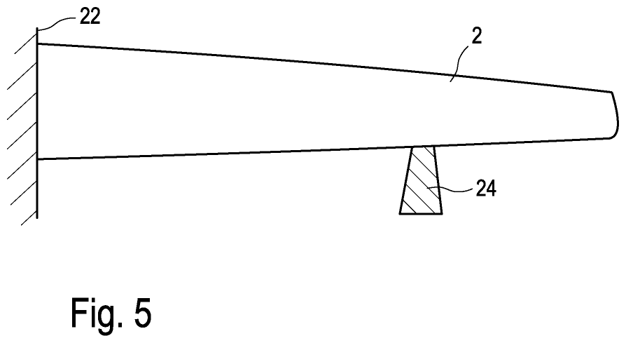

FIG. 5 shows a side view of an example of a measured object 2, specifically a rotor blade of a wind power installation. The rotor blade 2 is fastened in a stationary holder 22 at its hub end. In order to reduce sagging of the rotor blade, the rotor blade 2 is supported by at least one support apparatus 24. In this example, the support apparatus 24 is spaced apart from the blade tip by approximately one third of the blade length. In other examples, the support apparatus 24 can also be provided at other points of the blade and use can also be made of more than one support apparatus 24 for supporting the rotor blade 2.

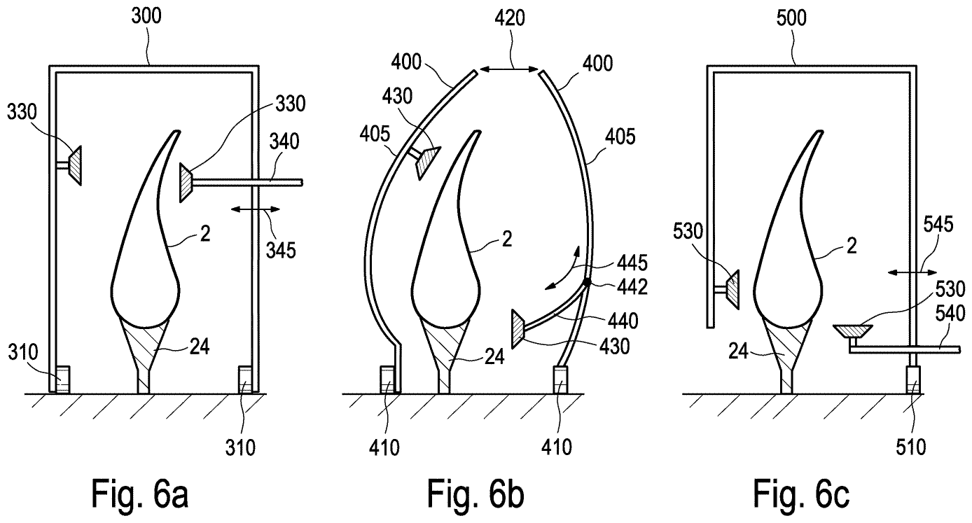

On account of the support apparatus 24, it is not possible to displace a closed portal along the entire rotor blade 2. FIGS. 6a to 6c show three exemplary embodiments of a carrier unit 300, 400 and 500 which can be moved along the entire rotor blade 2, despite the provided support apparatus 24.

FIG. 6a shows a carrier unit 300, which is embodied in the form of an inverted U. In this example, the movement unit of the carrier unit 300 comprises two wheels 310, which are each provided at a lower end of the vertical frame elements. FIG. 6a shows two measurement sensors 330, which are arranged at opposite sides of the rotor blade 2. The measurement sensor 330 lying on the side shown on the right in the drawing is displaceable along a direction 345 in the measurement plane by means of an advancing unit 340. In an example, the measurement sensor 330 can also be rotatably mounted in relation to the advancing unit 340 and consequently be advanced in relation to two axes. In this example, the advancing unit 340 is further shown halfway up the rotor blade 2; in other examples, the displacement unit 340 can also be arranged at other positions with respect to the rotor blade or it can be assembled to be adjustable with respect to the carrier unit 300.

FIG. 6b shows a further exemplary embodiment of a carrier unit 400. The carrier unit 400 is composed from two frame elements 405, which are respectively arranged on a pressure side and a suction side of the rotor blade 2. The two sides 405 are not connected to one another and are displaceable relative to one another in a direction 420. To this end, the respective frame elements 405 have wheels 410. FIG. 6b also shows two measurement sensors 430. One of the measurement sensors 430, which is shown to the right in the drawing, is arranged to be pivotable in a direction 445 with respect to the carrier unit 400 at a pivot 442 via a displacement unit 440. In order to pass the position of the rotor blade 2 at which the support apparatus 24 is arranged, the two frame elements 405 are moved apart. As a result, the pivotable sensor 430 on the right-hand side is not situated below the rotor blade 2. After passing, the sensor can be positioned, again, below the rotor blade 2 in the vicinity of the leading edge of the rotor blade 2. Consequently, it is possible to ensure a high resolution the leading-edge region, which is a very sensitive region in respect of the aerodynamics. While the frame elements 405 in this example can be moved apart from one another and the advancing unit 440 facilitates a rotatable advance of the measurement sensor 430, the frame is either constructed from two frame elements 405 or one of the measurement sensors can be advanced in a rotatable manner in other examples. Combinations with other exemplary embodiments also are advantageously possible.

FIG. 6c schematically shows a further exemplary embodiment of a carrier unit 500. The carrier unit 500 stands on the ground on the right-hand side in the drawing by means of a stand element 510. By way of example, the stand element 510 may also comprise wheels. In this exemplary embodiment, too, only two measurement sensors 530 are shown schematically, of which the one shown to the right in the drawing can be advanced along an advanced direction 545 by means of an advancing element 540. After passing the support element 24, the sensor 530 shown on the right-hand side in the drawing can consequently be positioned below and in the vicinity of the leading edge of the rotor blade 2, without impairing the displacement of the carrier unit 500 along the measured object.

In other exemplary embodiments, the carrier unit 3, 300, 400, 500 may also comprise the advancing element in integrated fashion. As a result, measurement sensors, for example, can be advanced in the measurement plane by advancing part of the entire frame, etc., of the carrier unit 3, 300, 400, 500. Although the shown exemplary embodiments elucidate a rotor blade 2 of a wind power installation as an example of a measured object, the effects and advantages obtained by the invention are also applicable to other measured objects, in particular elongate measured objects with a varying cross section.

1-21. (canceled)

22. A measurement system for measuring a surface of a rotor blade of a wind power installation as a measured object, comprising:
a carrier unit having a plurality of measurement sensors arranged in a measurement plane, wherein the measurement system is configured to align the measurement plane with a profile section of the measured object,
a movement unit configured to move the carrier unit relative to the measured object in a longitudinal direction that is at an angle to the measurement plane, and
an advancing unit configured to advance at least one measurement sensor of the plurality of measurement sensors in the measurement plane relative to the profile section,
wherein the plurality of measurement sensors are configured as laser section sensors, and
wherein the advancing unit is configured to advance to a distance between the at least one measurement sensor and the measured object in such a way that a requirement with respect to a measurement resolution of the at least one measurement sensor with respect to the surface of the measured object is satisfied both in a hub region of the rotor blade and in a blade-tip region.

23. The measurement system as claimed in claim 22, wherein the advancing unit has a mechanical advancing element configured to mechanically advance the at least one measurement sensor.

24. The measurement system as claimed in claim 22, wherein the advancing unit has a linear advancing element, and wherein an axis of the linear advancing element extends in the measurement plane.

25. The measurement system as claimed in claim 22, wherein the plurality of measurement sensors are each configured to capture part of the profile section of the measured object in the measurement plane, and further comprising a calculation unit configured to combine the captured parts of the profile section to form an overall profile section.

26. The measurement system as claimed in claim 25, wherein the calculation unit is configured to combine profile sections at different positions of the carrier unit in the longitudinal direction to form a profile of the surface of the measured object.

27. The measurement system as claimed in claim 25, wherein the calculation unit is configured to compare the captured profile section or the captured profile to a reference profile section or a reference profile, and wherein the calculation unit is configured to determine if a deviation between the reference profile section or the reference profile and the captured profile section or profile exceeds a predetermined tolerance value.

28. The measurement system as claimed in claim 27, wherein the calculation unit is further configured to undertake a correction of the captured profile section or of the captured profile on the basis of an inherent weight of the measured object and gravity.

29. The measurement system as claimed in claim 22, wherein the carrier unit is embodied as a portal, wherein the plurality of measurement sensors are directed in a direction of an interior of the portal.

30. The measurement system as claimed in claim 22, wherein the carrier unit is configured to be arranged within the profile section of the measured object, wherein the plurality of measurement sensors are directed away from the carrier unit to the outside of the measurement system.

31. The measurement system as claimed in claim 22, wherein the movement unit has a guide component and a motor, wherein the guide component defines the longitudinal direction and the movement unit is configured to move the carrier unit along the guide component by the motor.

32. The measurement system as claimed in claim 22, further comprising a position determination unit configured to determine the position of the carrier unit along the longitudinal direction.

33. The measurement system as claimed in claim 32, wherein the carrier unit has a retroreflector and wherein the position determination unit is configured to determine the position of the carrier unit by the retroreflector.

34. A measurement method for measuring a surface of an object, the method comprising:
aligning a carrier unit with a plurality of measurement sensors, arranged in a measurement plane, with a profile section of the object, wherein the plurality of measurement sensors are configured as laser section sensors,
moving the carrier unit in a longitudinal direction, at an angle to the measurement plane, relative to the object, and
advancing at least one of the measurement sensors of the plurality of measurement sensors in the measurement plane relative to the profile section in such a way that the distance between the at least one measurement sensor and the object satisfies a requirement with respect to a measurement resolution of the at least one measurement sensor with respect to the surface of the object.

35. The measurement method as claimed in claim 34, wherein, in each case, at least one profile section of the object is captured before and after moving the carrier unit and advancing at least one of the measurement sensors.

36. The measurement method as claimed in claim 35, wherein a position of the carrier unit in the longitudinal direction is captured for each profile section.

37. The measurement method as claimed in claim 36, wherein at least one profile section is corrected depending on its position in the longitudinal direction.

38. The measurement method as claimed in claim 37, wherein a surface profile of the object is calculated from the captured profile sections.

39. The measurement method as claimed in claim 34, wherein the object is a rotor blade of a wind power installation.

40. A method comprising:
using the measurement system as claimed in claim 1 to initially measure a surface of the measured object at a first resolution,
comparing the measured surface of the object at the first resolution to a reference surface; and
when a deviation of the comparison exceeds a threshold value, using the measurement system to measure the surface of the measured object at a second, higher resolution.
